(19) United States
(12) Patent Application Publication
(10) Pub. No.: US 2011/0102293 A1
(43) Pub. Date: May 5, 2011

(54) Antenna Assembly

(75) Inventors: Jun Jie Chen, Shanghai (CN); Min Ding, Shanghai (CN); Jun Ping Geng, Shanghai (CN); Xian Guang Guo, Shangahi (CN); Rong Hong Jin, Shanghai (CN); Mattias Lampe, Wolfenbuettel (DE); Christoph Weiler, Bretten (DE)

(73) Assignee: Siemens AG, Munchen (DE)

(21) Appl. No.: 12/937,083

(22) PCT Filed: Apr. 10, 2008
(86) PCT No.: PCT/CN2008/000738

§ 371 Date: Dec. 30, 2010

(51) Int. Cl. H01Q 3/24

(52) U.S. Cl. 343/876

(57) ABSTRACT

An antenna module that includes two directional antennae arranged in a back-to-back manner, and a converter. The converter realizes conversion between an omnidirectional antenna mode and a directional antenna mode by switching on two directional antennae simultaneously or by switching on one of the directional antennas. Alternatively, the antenna module includes a horizontal polarization antenna, a vertical polarization antenna and a converter, where the converter provides the conversion between the horizontal polarization antenna mode and the vertical polarization antenna mode by switching on the horizontal polarization antenna or the vertical polarization antenna.

### CROSS-REFERENCE TO RELATED APPLICATIONS

This is a U.S. national stage of International Application No. PCT/CN2008/000738, filed on 10 Apr. 2008. The entire content of the application is incorporated herein by reference.

### BACKGROUND OF THE INVENTION

1. Field of the Invention

The present invention relates to antenna technology and, more particularly, to an antenna assembly that can switch between an omnidirectional antenna mode and directional antenna mode, and an antenna assembly that can switch between a vertically polarized antenna mode and horizontally polarized antenna mode.

2. Description of the Related Art

In a wireless communication system, such as a wireless local area network (WLAN), a communication link is established between a network device and a terminal device for information transfer. Here, the network device should be able to move randomly depending on actual application scenarios and different environments or should be installed on a fixed structure, such as a wall.

In certain cases, it is desirable for the same network device to support multiple installation modes. For example, in an office, it is desirable to install the access point device located in the wireless local area network on a wall or to place the access point device on a desk.

When a network device can be moved, an omnidirectional antenna is often needed for receiving and sending data. When a network device with an omnidirectional antenna is installed on a wall, a large portion of the signals may be absorbed and reflected by the wall. As a result, the emitted signals are weakened or the signal component reflected by the wall counteracts the signal component in the desired direction. At the time of signal reception, the absorption and reflection of the signals by the wall, and the noises and interferences reflected by the wall will all affect the signal receiving performance of the network device.

The present patent application utilizes the exemplary WLAN for the following description but the technical solution provided by the present application is also applicable to other wireless communication systems. WLAN can provide wireless network access and high-speed internet access at home, in the office and other places without a network connection cable. For example, in an office, it is very convenient for users to keep their notebook PCs connected to the network in different rooms, without having to repeatedly connect the network cable.

Today, most WLAN network devices use an omnidirectional antenna by default. For certain WLAN network devices, it is acceptable to replace the original antenna with a different antenna. For such network devices, an antenna interface that is compatible with the device may be installed on the WLAN network device, for example, a directional antenna interface and omnidirectional antenna interface. If directional antenna is needed, a directional antenna can be installed on the device. Likewise, if an omnidirectional antenna is needed, the original directional antenna can be replaced with an omnidirectional antenna.

Even so, most conventional antennas for network devices still cannot adapt well to different application scenarios and installation locations. Moreover, in different network device applications, a considerable load of extra antenna debugging work is needed, such as frequent changes of the antenna, making it very inconvenient to use the network device.

### SUMMARY OF THE INVENTION

It is therefore an object of the present invention to provide an antenna assembly which can switch between an omnidirectional antenna mode and directional antenna mode.

It is a further object of the present invention to also provide an antenna assembly which can switch between a vertically polarized antenna mode and a horizontally polarized antenna mode.

These and other objects and advantages are achieved in accordance with the invention by providing an antenna assembly which comprises a first directional antenna, a second directional antenna, and a switcher for switching the antenna assembly between an omnidirectional antenna mode and a directional antenna mode, where the first directional antenna and the second directional antenna are arranged in a back-to-back configuration. Here, the switcher comprises a device connection terminal, and a first and a second antenna connection terminal, where the device connection terminal is used to connect to a wireless device, and the first and second antenna connection terminals connect to the first directional antenna and the second directional antenna, respectively. Moreover, when both antenna connection terminals of the switcher are selected, the antenna assembly operates in the omnidirectional antenna mode. When one of the first and second antenna connection terminals of the switcher is selected, the antenna assembly operates in the directional antenna mode.

In an alternative embodiment, the switcher comprises a divider/combiner and an on-off radiofrequency (RF) switch, where the divider/combiner comprises one input terminal and two output terminals. Here, the input terminal connects to the device connection terminal, one of the two output terminals connects to the first antenna connection terminal, and the other one of the two output terminals connects to the second antenna connection terminal through the RF switch. When the RF switch connects the output terminal to the second antenna connection terminal, the antenna assembly operates in the omnidirectional antenna mode. On the other hand, when the RF switch disconnects the output terminal from the second antenna connection terminal, the antenna assembly operates in the directional antenna mode.

Preferably, the switcher comprises a divider/combiner, and a first, a second and a third single-pole-double-throw (SPDT) RF switch, where the divider/combiner comprises one input terminal and two output terminals. Here, the input terminal connects to the device connection terminal through the first SPDT RF switch, one of the two output terminals connects to the first antenna connection terminal through the second SPDT RF switch, and the other one of the two output terminals connects to the second antenna connection terminal through the third SPDT RF switch. Moreover, a gating terminal of the first SPDT RF switch connects to a gating terminal of the third SPDT RF switch, and the first SPDT RF switch and the third SPDT RF switch perform synchronized switching. When the first SPDT RF switch connects the device connection terminal to the input terminal while the third SPDT RF switch connects the output terminal to the second antenna connection terminal, the antenna assembly operates in the omnidirectional antenna mode. Moreover, after the first SPDT RF switch and the third SPDT RF switch perform synchronized switching, and when the device connection terminal is connected to the second antenna connection terminal, the antenna assembly operates in the directional antenna mode.

Preferably, the switching of the antenna mode is controlled by a software program.

In preferred embodiments, the antenna assembly further comprises a proximity sensor and a control unit, where the proximity sensor is used to detect the installation position of said wireless device, and transmits the detected installation position information to the control unit, the control unit is used to-control status switching of each of the RF switches in accordance with the detected installation position information.

In another embodiment, the antenna assembly comprises a horizontally polarized antenna, a vertically polarized antenna, and a switcher for switching said antenna assembly between the horizontally polarized antenna mode and the vertically polarized antenna mode, where the switcher comprises a device connection terminal, and a first and a second antenna connection terminal. Here, the device connection terminal is used to connect to a wireless device, and the first and second antenna connection terminals connect to the horizontally polarized antenna and the vertically polarized antenna, respectively. When only the first antenna connection terminal is selected, the antenna assembly operates in the horizontally polarized antenna mode. On the other hand, when, only the second antenna connection terminal is selected, the antenna assembly operates in the vertically polarized antenna mode.

Optionally, the horizontally polarized antenna and the vertically polarized antenna are arranged in one plane.

Optionally, the horizontally polarized antenna and the vertically polarized antenna are arranged in different planes.

In preferred embodiments, the switcher comprises an SPDT RF switch, where the input terminal of the SPDT RF switch connects to the device connection terminal, and the two gating terminals of the SPDT RF switch connect to the first and the second antenna connection terminals, respectively. When the SPDT RF switch connects the device connection terminal to the first antenna connection terminal, the antenna assembly operates in the horizontally polarized antenna mode. On the other hand, when the SPDT RF switch connects the device connection terminal to the second antenna connection terminal, the antenna assembly operates in the vertically polarized antenna mode.

Preferably, the switching of the antenna mode is controlled by a software program.

In preferred embodiments, antenna assembly also comprises an inclination sensor and a control unit. Here, the inclination sensor is used to detect the angle of inclination of the wireless device, and transmits the detected angle of inclination information to the control unit, Here, the control unit is used to control the switching of the antenna modes according to the detected angle of inclination information.

With the antenna assembly provided by the disclosed embodiments of the present invention, directionalities of the antenna directional pattern or antenna polarization modes of the antenna assembly can be flexibly switched, which enables a wireless device to be well-adapted to the demands of different application scenarios and installation positions for data receiving and sending, and simplifies the use and operation of the wireless device. In addition, the disclosed embodiments of the present invention provide a further proximity sensor and inclination sensor in the two kinds of antenna assemblies, and enables the antenna assembly switching under control of a separate control unit according to detection information from the proximity sensor. As a result, the directionality of the antenna directional profile or antenna polarization modes of the antenna assembly can be self-adaptively adjusted, and the use and operation of the wireless device become much easier.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The following content will describe the illustrative embodiments of the present invention in detail with reference to the attached figures, so that persons of ordinary skill in the art can clearly understand the above and other features as well as the advantages of the present invention, wherein in the figures:

FIG. 1 is a schematic block diagram illustrating an antenna array structure of an antenna assembly in accordance with an embodiment of the invention;

FIG. 2 is a schematic block diagram illustrating a three-dimensional (3D) structure of a first directional antenna and a second directional antenna in the antenna assembly of FIG. 1;

FIG. 3 is a schematic block diagram illustrating the operational features of the antenna assembly of FIG. 1;

FIG. 4a is a graphical plot illustrating a radiation power curve in an omindirectional antenna mode when configuring the antenna assembly of FIG. 1 to receive and send signals;

FIG. 4b is a graphical plot illustrating a radiation power curve in directional antenna mode when configuring the antenna assembly of FIG. 1 to receive and send signals;

FIG. 5 is a schematic block diagram illustrating the operational features of the antenna assembly in accordance with an alternative embodiment of the present invention;

FIG. 6 is a schematic block diagram illustrating an antenna array structure of the antenna assembly in accordance with an alternative embodiment of the present invention;

FIG. 7 is a schematic block diagram illustrating the 3D antenna structure of the antenna assembly of FIG. 6; and

FIG. 8 is a schematic block diagram illustrating the operational features of the antenna assembly of FIG. 6.

### DETAILED DESCRIPTION OF THE PREFERRED EMBODIMENTS

In order to further clarify the purposes, technical solution and advantages of the present invention, more details are given below in conjunction with drawings and embodiments. It shall be understood that the particular embodiments described herein are only used to explain the present invention, and are not intended to limit the present invention.

In a wireless communication system, in order to reduce the extra work in adapting the network devices in actual applications and to simplify the use and operation of network devices, the present invention provides an antenna assembly comprising multiple antennas, where the antenna assembly can flexibly switch between different operational modes so that the network device can adapt optimally to the transceiving needs of different application scenarios and installation positions.

The present invention provides an antenna assembly that can switch between an omnidirectional antenna mode and a directional antenna mode. The antenna assembly comprises a first directional antenna, a second directional antenna, and a switcher for switching the antenna assembly between the omnidirectional antenna mode and the directional antenna mode, where the first directional antenna and the second directional antenna are arranged in a back-to-back manner. The switcher comprises a device connection terminal, and a first and a second antenna connection terminal, where the device connection terminal is used to connect to a wireless device, such as a WLAN network device, and the first and second antenna connection terminals connect to the first directional antenna and the second directional antenna, respectively. When both antenna connection terminals of the switcher are selected, the antenna assembly operates in the omnidirectional antenna mode. When one of the two antenna connection terminals of the switcher is selected, the antenna assembly operates in the directional antenna mode.

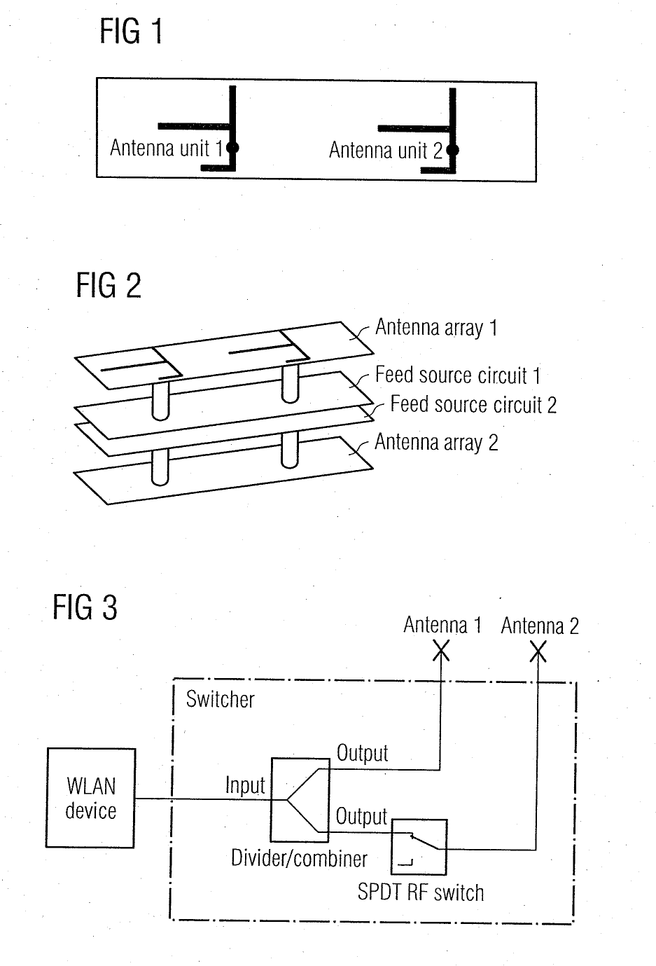

FIG. 1 is a schematic diagram showing the antenna array structure of the antenna assembly in accordance with an embodiment of the present invention. As shown in FIG. 1, the antenna array preferably comprises two antenna units. Compared with the scenario of using only one antenna unit, using multiple antenna units has the advantages of having greater gain in the E-plane directional pattern. In the present embodiment, when an antenna array comprises two antenna units, a gain of greater than 6 dB can be obtained in the E-plane directional pattern of the antennas.

FIG. 2 is a schematic diagram showing the three-dimensional (3D) structure of the first and the second directional antennas in the antenna assembly according to embodiment 1 of FIG. 1, where each directional antenna may consist of an antenna array, which is composed of two antenna units, and a feed source circuit, and is presented as a microstrip structure. As shown in FIG. 2, the antenna array 1 and feed source circuit 1 constitutes the first directional antenna, the antenna array 2 and feed source circuit 2 constitutes the second directional antenna, and the first directional antenna and the second directional antenna are arranged in a back-to-back manner. The antenna array 1 and antenna array 2 receive the signal feed of a radiofrequency signal source though the feed source circuit 1 and feed source circuit 2, respectively. Each feed source circuit may consist of a metal feeder panel, a dielectric layer and an earthing/grounding plate. The earthing/grounding plate of feed source circuit 1 is on the upper surface of the feed source circuit 1, and the earthing plate of feed source circuit 2 is on the lower surface of the feed source circuit 2. These earthing/grounding plates constitute the reflecting plates of antenna array 1 and antenna array 2 respectively, and are used to form the H-plane directional pattern of the first directional antenna and the second directional antenna.

In a first embodiment, the antenna assembly can switch between the directional antenna mode and omnidirectional antenna mode through the switcher shown in FIG. 3. As shown in FIG. 3, it is assumed that the directional antenna 1 and directional antenna 2 in FIG. 3 represent a forward antenna and a backward antenna, respectively. Here, the switcher may comprise a divider/combiner and a single-pole-double-throw radiofrequency (SPDT RE) switch. The divider/combiner is used to either divide the single input signal source into two output signal sources, or combine two input signal sources into one output signal source, and has one input terminal and two output terminals. Here, the input terminal connects to the device connection terminal, one of the two output terminals connects to the first antenna connection terminal, and the other one of the two output terminals connects to the second antenna connection terminal through the RF switch. When the RF switch connects the output terminal to the second antenna connection terminal, both directional antenna 1 and directional antenna 2 can obtain the feed source, and the antenna assembly operates in the omnidirectional antenna mode. When the RF switch disconnects the output terminal from the second antenna connection terminal, only the directional antenna 1 can obtain the feed source, and the antenna assembly operates in the directional antenna mode.

In the embodiment depicted in FIGS. 1-3, the functions of the SPDT RF switch can also be more simply achieved through a make-break RF switch.

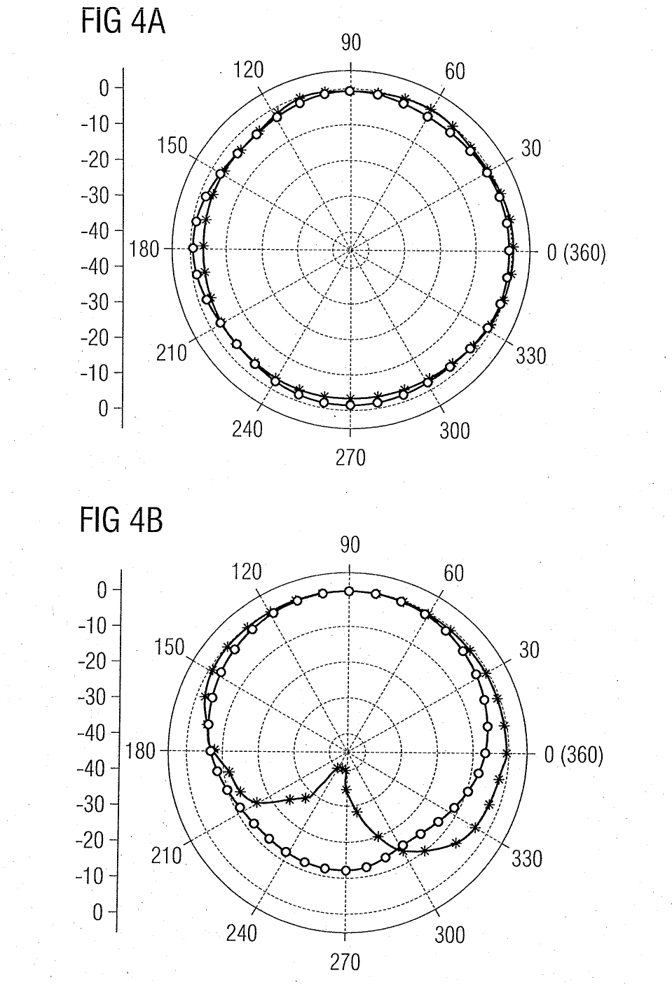

FIG. 4a is a graphical plot illustrating a radiation power curve in the omnidirectional antenna mode when configuring the antenna assembly of FIG. 1 to receive and send signals. As shown in FIG. 4a, circles marked with a number of 0˜360 represent the angle coordinate and indicate the angle value of the antenna assembly in the H-plane directional pattern, and the Y-coordinate represents the ratio (dB) of antenna radiation power at each angle to the maximum antenna radiation power. The antenna assembly operates at an operating frequency of 2.45 GHz, where the closed curve marked with “*” in the angle coordinate represents the antenna radiation power curve profile obtained by measurement, and the closed curve marked with “o” in the angle coordinate represents the antenna radiation power curve profile obtained by simulation.

FIG. 4b is a graphical plot illustrating a radiation power curve in the directional antenna mode when configuring the antenna assembly of the first embodiment to receive and send signals. As shown in FIG. 4b, circles marked with 0˜360 represent the angle coordinate and indicate the angle value of the antenna assembly in the H-plane directional pattern, and the Y-coordinate represents the ratio (dB) of antenna radiation power at each angle to the maximum antenna radiation power. The antenna assembly works at the operational frequency of 2.45 GHz, where the closed curve marked with “*” in the angle coordinate represents the antenna radiation power curve profile obtained by measurement, and the closed curve marked with “o” in the angle coordinate represents the antenna radiation power curve profile obtained by simulation.

According to the antenna radiation power curve profile shown in FIG. 4a and FIG. 4b, it is easy to find that in the directional antenna mode, the antenna assembly backward (from 180° to 360° in the angle coordinate) radiation power is much smaller than the forward (from 0° to 180° in the angle coordinate) radiation power. In other words, if the WLAN network device is installed on the wall, the antenna assembly can be made to operate in the directional antenna mode by controlling the operational mode of the antenna assembly, thus effectively avoiding the absorption and reflection by the wall of the radiation power of the antenna assembly, and reducing the likelihood that the signal component is weakened due to wall absorption and the possibility that the signal component reflected by the wall counteracts the signal component in the desired direction. Meanwhile, at the time of signal reception, the effect of the noise and interference which is absorbed and reflected by the wall on the received signals is significantly reduced.

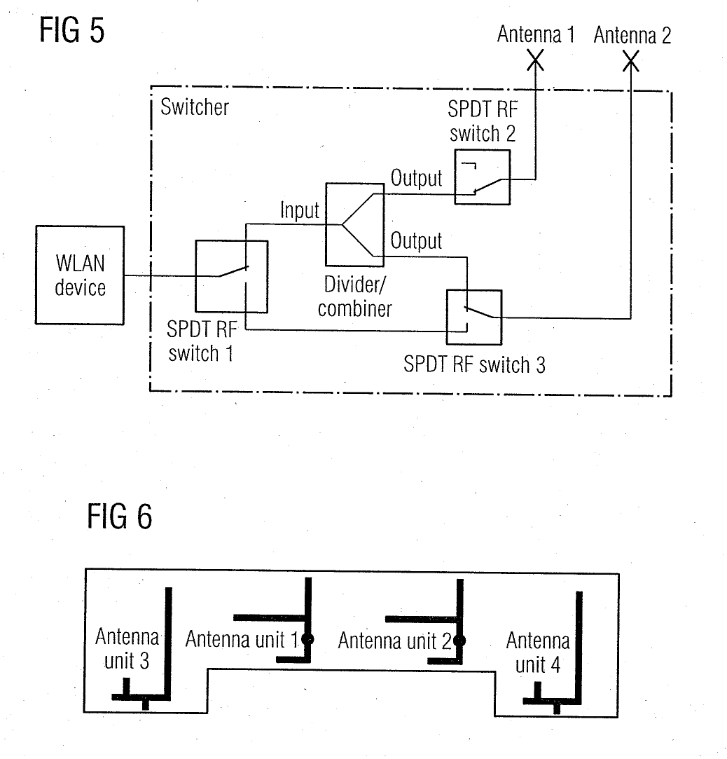

In the antenna assembly in accordance with an alternative embodiment of the invention, the first directional antenna and the second directional antenna have the same structure as that shown in FIG. 1 and FIG. 2. Here, the antenna assembly can switch between the omnidirectional antenna mode and directional antenna mode through the switcher shown in FIG. 5. As shown in FIG. 5, at this time, the switcher comprises a divider/combiner, a SPDT RF switch 1, a SPDT RF switch 2 and a SPDT RF switch 3. The divider/combiner has one input terminal and two output terminals, where the input terminal connects to a device connection terminal of the switcher through the SPDT RF switch 1, and the device connection terminal is used to connect to a wireless device. One of the two output terminals connects to the first antenna connection terminal of the switcher through the SPDT RF switch 2, and the first antenna connection terminal further connects to the directional antenna 1. The other of the two output terminals connects to the second antenna connection terminal of the switcher through the SPDT RF switch 3, and the second antenna connection terminal further connects to the directional antenna 2. One gating terminal of the SPDT RF switch 1 connects to one gating terminal of the SPDT RF switch 3, and the SPDT RF switch 1 and SPDT RF switch 3 perform synchronized switching.

When the SPDT RF 1 connects the device connection terminal to the input terminal, while SPDT RF 3 connects the output terminal to the second antenna connection terminal, both the directional antenna 1 and directional antenna 2 can obtain the feed source, and the antenna assembly works in the omnidirectional antenna mode. After the SPDT RF switch 1 and SPDT RF switch 3 complete the synchronized switch, and when the device connection terminal and the second antenna connection terminal are selected, only the directional antenna 2 can obtain the feed source, and the antenna assembly operates in the directional antenna mode.

In the antenna assembly in accordance with the alternative embodiment of the invention, the purpose of setting SPDT RE 2 in the switcher is to ensure that the resistances of the two antenna connection terminals of the switcher match each other. When the divider/combiner by design alone can solve the problem of different insertion losses at its two output terminals, and ensure that the resistances of the two antenna connection terminals match each other, the switcher in the contemplated embodiment can be simply the one used in the previously described embodiment.

In the contemplated embodiments of the antenna assembly of the present invention, the switching of the antenna assembly operational mode, or the status switching of each of the RF switches, can be controlled by the software program. According to different application scenarios and different installation positions of the network device, the operational mode of the antenna assembly can be configured through the software program. The configuration instructions sent from the software program can be further converted into controlling voltages by a logical circuit, and the status switching of the RF switches can be controlled through different controlling voltages.

In addition, the antenna assembly in accordance with the contemplated embodiments of the present invention may also comprise a proximity sensor and a control unit. Here, the proximity sensor is used to detect the installation positions, for example, installed on a wall or a desk, of the wireless device that incorporates the antenna assembly, and transmit the detected installation position information to the control unit. The control unit controls the status switching of each of the RF switches according to the different installation positions, thus switching the operational mode of the antenna assembly. For example, when the proximity sensor detects that the antenna device is installed near a wall, the control unit can control the antenna assembly so that it operates in the directional antenna mode according to such installation position detection information. When the proximity sensor detects that the wireless device is installed in a location at which no obstacle is located close by, the control unit can accordingly control the antenna assembly to operate in the omnidirectional antenna mode. In this way, the antenna assembly can self-adaptively adjust its H-plane antenna directional pattern according to different application scenarios and installation positions of the wireless device, so that different usage demands can be satisfied more flexibly and conveniently.

In a different wireless communication system, electromagnetic wave signals can be transmitted in a different polarized mode, such as the commonly-used horizontally polarized mode or vertically polarized mode. Accordingly, a horizontally polarized antenna or vertically polarized antenna is required to send and receive such electromagnetic wave signals. Furthermore, depending on the installation positions of the wireless device, for example, whether the wireless device is vertically or horizontally installed, it may also be necessary to adjust the antenna polarization mode of the wireless device.

The contemplated embodiments of the present invention also provide an antenna assembly that can switch between horizontal polarized antenna mode and vertically polarized antenna mode. Here, the antenna assembly comprises a horizontally polarized antenna, a vertically polarized antenna, and a switcher for switching the antenna assembly between the horizontally polarized antenna mode and the vertically polarized antenna mode. In this case, the switcher comprises a device connection terminal, a first antenna connection terminal and a second antenna connection terminal, the device connection terminal is used to connect to a wireless device, and the first and second antenna connection terminals connect to the horizontally polarized antenna and vertically polarized antenna, respectively. When only the first antenna connection terminal is selected, the antenna assembly operates in the horizontally polarized antenna mode. When only the second antenna connection terminal is selected, the antenna assembly operates in the vertically polarized antenna mode.

FIG. 6 is a schematic diagram showing the antenna array structure of the antenna assembly in accordance with an alternative embodiment of the present invention. As shown in FIG. 6, preferably, the antenna array may comprise a horizontally polarized antenna which is composed of two horizontally polarized antenna units, and a vertically polarized antenna which is composed of two vertically polarized antenna units. The horizontally polarized antenna and the vertically polarized antenna are arranged in a single plane. Here, the two horizontally polarized antenna units (antenna unit 1 and antenna unit 2) are adjacent to each other and are on the inner side, the two vertically polarized antenna units (antenna unit 3 and antenna unit 4) are on the outer side of the two horizontally polarized antenna units, respectively, and the space between the antenna units is at least a half wavelength.

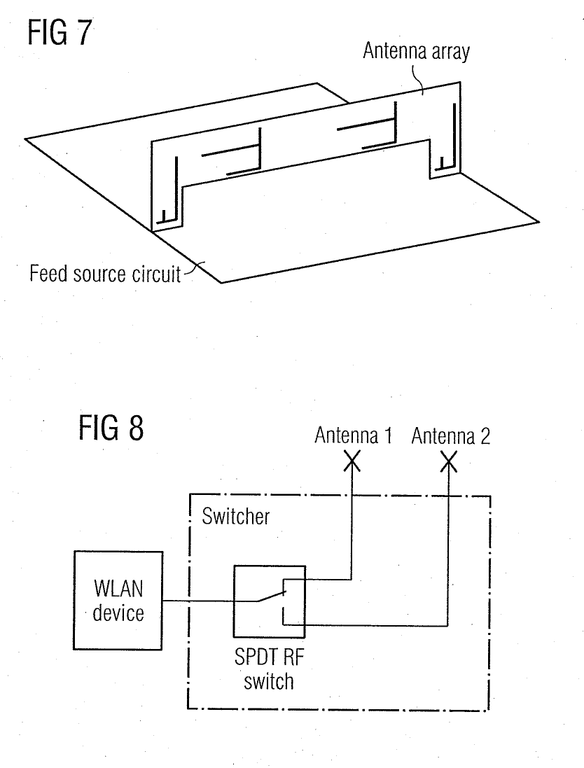

FIG. 7 is a schematic diagram illustrating the three-dimensional (3D) structure of the antenna assembly of the embodiment depicted in FIG. 6. As shown in FIG. 7, the antenna comprises an antenna array that is composed of the horizontally polarized antenna and the vertically polarized antenna, and a feed source circuit. Here, the antenna array is installed perpendicular to the Earth (i.e., vertically), and the feed source circuit is installed parallel with the Earth (i.e., horizontally). The antenna array receives the feed of a radiofrequency signal source through the feed source circuit. The feed source circuit can comprise a metal feeder panel, a dielectric layer and an earthing/grounding plate. The earthing/grounding plate is on the upper surface of the feed source circuit, constitutes the reflection plate of the antenna array, and is used to form the H-plane directional pattern of the antenna.

In the embodiment depicted in FIG. 6, the antenna assembly can switch between the horizontally polarized antenna mode and vertically polarized antenna mode through the switcher shown in FIG. 8. As shown in FIG. 8, it is assumed that antenna 1 and antenna 2 represent the horizontally polarized antenna and vertically polarized antenna, respectively. The switcher comprises a SPDT RF switch. An input terminal of the SPDT RF switch connects to the device connection terminal, and two gating terminals of the SPDT RF switch connect to the first and second antenna connection terminals, respectively.

When the SPDT RF switch connects the device connection terminal to the first antenna connection terminal, only antenna 1 can obtain the feed source, and the antenna assembly operates in the horizontally polarized antenna mode. When the SPDT RF switch connects the device connection terminal to the second antenna connection terminal, only antenna 2 can obtain the feed source, and the antenna assembly operates in the vertically polarized antenna mode.

In the currently contemplated embodiment, optionally, the horizontally polarized antenna and the vertically polarized antenna can also be arranged in different planes, for example, the two antenna planes are perpendicular to each other to adapt to different installation modes and application needs of the wireless device.

In the antenna assembly in accordance with the embodiment shown in FIG. 6, the switching of the antenna assembly polarization mode can also be controlled by a software program.

According to different application scenarios and installation positions of the network device, the polarization mode of the antenna assembly can be configured through the software program. The configuration instructions sent from the software program can be further converted to controlling voltages by a logical circuit, and the status switching of the RF switch can be controlled through different controlling voltages, so as to control the polarization mode switching of the antenna assembly.

In addition, the antenna assembly of FIG. 6 in a further embodiment may further comprise an inclination sensor and a control unit. The inclination sensor is used to detect the angle of inclination of the wireless device which is provided with the antenna assembly, for example, placing it horizontally on a desk or installing it vertically on a wall, and transmit the detected angle of inclination information to the control unit. According to different inclination angles, the control unit controls the status switching of the RF switch so as to select to connect the horizontally polarized antenna or the vertically polarized antenna. For example, in a wireless communication system that transmits signals in the vertically polarization mode, the wireless device is placed horizontally in the normal use status, where the vertically polarized antenna of the antenna assembly is selected, and the antenna assembly operates in the vertically polarized antenna mode. When the inclination sensor detects that the wireless device is vertically installed on a wall such that the position of the antenna assembly is inclined by 90°, the control unit can control the status switching of the RF switch according to such a detected angle of inclination information and accordingly select the originally horizontally polarized antenna, so as to ensure that the wireless device can still receive and send signals in the vertically polarized mode. This presently contemplated embodiment enables the antenna assembly to self-adaptively adjust its polarization direction according to the application scenarios and installation position changes of the wireless device. The above only describes the preferred embodiments of the present invention, and is not intended to limit the present invention. Any modifications, equivalent substitutions and improvements made without departing from the spirit and principle of the present invention are within the protective scope of the present invention.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-11. (canceled)

12. An antenna assembly, comprising:
a first directional antenna;
a second directional antenna; and
a switcher for switching the antenna assembly between an omnidirectional antenna mode and a directional antenna mode;
wherein the first directional antenna and the second directional antenna are arranged in a back-to-back manner;
wherein the switcher comprises a device connection terminal, and a first and a second antenna connection terminal, said device connection terminal being configured for connection to a wireless device, and the first and second antenna connection terminals being configured to connect to the first directional antenna and the second directional antenna, respectively;
wherein, when the first and second antenna connection terminals of the switcher are selected, the antenna assembly operates in the omnidirectional antenna mode; and
wherein, when a single one of the first and second antenna connection terminals of the switcher is selected, the antenna assembly works in the directional antenna mode.

13. The antenna assembly as claimed in claim 12, wherein the switcher further comprises a divider/combiner and an on/off radiofrequency (RF) switch;
wherein the divider/combiner comprises an input terminal and a plurality of output terminals, said input terminal being configured to connect to the device connection terminal, one of said plural output terminals being configured to connect to the first antenna connection terminal, and another of said plural output terminals being configured to connect to the second antenna connection terminal through said RF switch;
wherein, when the RF switch connects the another of said output terminals to the second antenna connection terminal, the antenna assembly operates in the omnidirectional antenna mode; and
wherein, when the RF switch disconnects the another of said output terminals from the second antenna connection terminal, the antenna assembly operates in the directional antenna mode.

14. The antenna assembly as claimed in claim 12, wherein the switcher comprises a divider/combiner, a first, a second and a third single-pole-double-throw (SPDT) RF switch;
wherein the divider/combiner comprises an input terminal and a plurality of output terminals, said input terminal being configured to connect to the device connection terminal through the first SPDT RF switch, one of the plural output terminals is configured to connect to the first antenna connection terminal through the second SPDT RF switch, and another of the plural output terminals is configured to connect to the second antenna connection terminal through the third SPDT RF switch;
wherein a gating terminal of the first SPDT RF switch is configured to connect to a gating terminal of the third SPDT RF switch, and the first SPDT RF switch and the third SPDT RF switch perform synchronized switching;
wherein, when the first SPDT RF switch connects the device connection terminal to the input terminal while the third SPDT RF switch connects the another of the output terminals to the second antenna connection terminal, the antenna assembly operates in the omnidirectional antenna mode; and
wherein after the first SPDT RF switch and the third SPDT RF switch perform synchronized switching, and when the device connection terminal is connected to the second antenna connection terminal, the antenna assembly operates in the directional antenna mode.

15. The antenna assembly as claimed in claim 12, wherein switching of an antenna mode is controlled by a software program.

16. The antenna assembly as claimed in claim 14, further comprising:
a control unit; and
a proximity sensor configured to detect an installation position of the wireless device and to transmit detected installation position information to the control unit; and
wherein the control unit controls status switching of each of the RF switches according to the detected installation position information.

17. An antenna assembly, comprising:
a horizontally polarized antenna;
a vertically polarized antenna; and
a switcher for switching the antenna assembly between a horizontally polarized antenna mode and a vertically polarized antenna mode;
wherein the switcher comprises a device connection terminal, and a first and a second antenna connection terminal;
wherein the device connection terminal is configured to connect to a wireless device, and the first and second antenna connection terminals connect to the horizontally polarized antenna and the vertically polarized antenna, respectively;
wherein, when only the first antenna connection terminal is selected, the antenna assembly operates in the horizontally polarized antenna mode; and
wherein, when only the second antenna connection terminal is selected, the antenna assembly operates in the vertically polarized antenna mode.

18. The antenna assembly as claimed in claim 17, wherein the horizontally polarized antenna and the vertically polarized antenna are arranged in a single plane.

19. The antenna assembly as claimed in claim 17, wherein that the horizontally polarized antenna and the vertically polarized antenna are arranged in different planes.

20. The antenna assembly as claimed in claim 17, wherein the switcher further comprises:
a single-pole-double-throw (SPDT) radiofrequency (RF) switch;
wherein an input terminal of said SPDT RF switch is configured to connect to said device connection terminal, and two gating terminals of said SPDT RF switch are configured to connect to the first and the second antenna connection terminals, respectively;
wherein, when the SPDT RF switch connects the device connection terminal to the first antenna connection terminal, the antenna assembly operates in the horizontally polarized antenna mode; and
wherein, when the SPDT RF switch connects the device connection terminal to the second antenna connection terminal, the antenna assembly operates in the vertically polarized antenna mode.

21. The antenna assembly as claimed in claim 20, wherein switching of an antenna mode is controlled by a software program.

22. The antenna assembly as claimed in claim 20, further comprising:
a control unit; and
an inclination sensor configured to detect an angle of inclination of the wireless device and to transmit detected angle of inclination information to the control unit; and
wherein the control unit is configured to control switching of antenna modes according to the detected angle of inclination information.
